(19) United States
(12) Patent Application Publication
(10) Pub. No.: US 2020/0039763 A1
(43) Pub. Date: Feb. 6, 2020

(54) MOVEMENT OF PRODUCTS ON A LINE

(71) Applicant: GEBO PACKAGING SOLUTIONS FRANCE, Reichstett (FR)

(72) Inventor: Jean-Claude WAELDIN, Reichstett (JP)

(21) Appl. No.: 16/339,050

(22) PCT Filed: Oct. 3, 2017
(86) PCT No.: PCT/FR2017/052714

§ 371 Date: Apr. 3, 2019

(30) Foreign Application Priority Data
Oct. 4, 2016 (FR) 1659566

(51) Int. Cl. B65G 47/90; B65G 65/00; B66F 9/06

(52) U.S. Cl. CPC B65G 47/90; B65G 2201/0244; B66F 9/063; B65G 65/00

(57) ABSTRACT

Disclosed is a carriage, for moving bottle products from one station to another of a processing line for processing the products, the carriage being movable on a floor and including a self-contained drive configured to allow it to move from one predefined station to another predefined station. The carriage includes a plate, provided with a receiving surface suitable for receiving a plurality of products, and a shuttle, provided with the self-contained drive and a unit for engaging with/disengaging from the plate. Also disclosed is a corresponding processing line and method.

This invention relates to the field of equipment for conveying within an industrial line for processing products. It relates more particularly to a cart for moving products from one station to the next, with said cart comprising, on the one hand, a tray, and, on the other hand, a shuttle, as well as a corresponding line and method.

In the field of the invention, a product processing line generally comprises a set of consecutive stations, which transform the product until the final production of a pallet comprising a stacking of layers each comprising products, sometimes grouped into packs, cases, bundles, etc., is achieved. Downstream from the line, the full pallet is then processed for shipping, optionally by being sent to a logistical management center, in particular of the automatic storage unit type. The product processing lines affected by the invention therefore produce at least a secondary packaging function, thanks to which the products are prepared for bulk shipping one at a time. The line can also have upstream functions, such as preparation, production, manufacturing, storage, of the product itself, upstream from such a secondary packaging for shipping purposes.

A large quantity of consecutive identical products is therefore processed in a similar way within consecutive stations of the line. The line therefore continuously performs overall the same processing with consecutive products at an overall rate that defines the yield of the line.

This type of line is therefore necessarily equipped with means for moving products between the stations. Conventionally, these are mechanical conveyors of the endless-belt type, able to rotate continuously and on which the products rest by their lower part to be driven by it between its two ends. Suitable accumulation solutions also make it possible to make a buffer within the line.

A conveying solution for the processing line with one-at-a-time accumulation between two product processing stations is, for example, proposed in EP1497208 and is based on the succession of a module transforming a single-line flow into a multi-line flow, a module for accumulating such a multi-line flow, and then a module for transforming the multi-line flow into a single-line flow.

Another solution for movement between two processing stations one at a time is proposed in FR2998282 and is based essentially on a mechanical conveyance with an endless belt, a solution for transfer to a stationary accumulation table, to provide a transfer solution from said table to another mechanical endless-belt conveyor.

Other pieces of equipment for movement based on stationary mechanical conveyors are also proposed, for example, in EP2188199, or else in U.S. Pat. No. 6,206,174.

A shift in the use of such packaging lines toward smaller and smaller quantities of identical products is evident, however. The formats of processed products are therefore being forced to change more and more frequently, and the necessary changes and reconfigurations of the line are then themselves also more and more frequent. In addition, the change in format can require not only a new adjustment of the stations of the line, but also the substitution of certain stations of the line for others, compatible with the new processed product. This reconfiguration of the line in the area of the equipment that constitutes it is also brought about by the normal change of the line, to add thereto new machines, to replace certain others, etc.

It is therefore increasingly important to be able to use a packaging line, upstream from the logistical installation for processing full pallets, which is the most flexible possible, capable of adapting very quickly to new product formats and that is also very easy to shift toward new configurations. The line should also, preferably, ensure such flexibility and adaptability at the lowest possible cost.

It is possible to substitute the stationary mechanical conveyors by autonomous movable carts, which then perform this function of moving the products between the machines within the line. The machines, or processing stations, can therefore be stationary and positioned at different locations around the workshop, and even repositioned, even added, even eliminated, without having to reconsider the design of stationary mechanical conveying solutions. Adding a processing station into the line then optionally requires only that it be input into the programming of carts.

Nevertheless, the time of transfer and the presence of products can be quite long, which makes it necessary to use a large number of carts. However, their capacity for autonomous movement makes them quite costly.

The invention thus has as its object a cart for such a line, which makes it possible to achieve the expected flexibility and versatility, while providing a less costly solution.

For this purpose, the invention proposes substituting the stationary mechanical conveyors by, on the one hand, movable shuttles, and, on the other hand, trays that they move and on which the products are accommodated. Using, on the one side, a shuttle that ensures a movement function, and, on the other side, a tray that provides for the accommodation and support of products makes it possible to avoid leaving the shuttle on standby during the transfer of products to or from the tray and therefore to limit the fleet of shuttles needed to ensure a satisfactory flow for the line. This also makes it possible to use a standard shuttle, usable for moving trays of variable sizes.

This invention thus proposes a cart, for moving bottle-type products from one station to the next of a line for processing said products, said cart being able to move on a floor and comprising an autonomous driving means that is configured to make it possible for it to move from a predefined station to another predefined station. Said cart is special in that it comprises a tray that is equipped with a receiving surface that can accommodate a number of products and a shuttle that is equipped with said autonomous driving means and a means for engagement/disengagement in relation to said tray. The shuttle can then be moved independently of the tray, which can remain in place while the shuttle moves. The shuttle, drive element, and the tray, product support element, can therefore be disengaged so that one remains while the other moves, and can be engaged so that the shuttle drives the tray in its movement.

Thanks to these arrangements, and compared to the intermediate solution of carts integrating, in a non-disengageable way, a shuttle and a tray, the number of shuttles can be much less than the number of trays, and it is therefore possible to obtain the same service with fewer shuttles than there would have to be carts in the absence of the invention. Furthermore, the line is more flexible and adaptable, with a high product flow rate, and a movement solution that is less expensive and adaptable to all of the products.

According to other characteristics:
Said tray can comprise at least one, preferably four, retractable edge(s), configured to be able to be active, and to keep the products inside said receiving surface, and to be able to be retracted to make possible transfers by a lateral thrust from one surface to the next; a good hold is thus obtained during the movements, and an absence of obstacles during the transfers. The thrust is done through space released by the retracted edge,
Said tray can comprise a separate support structure, such as feet, in particular equipped with casters, which makes it possible for the receiving surface to be placed and held at the height of the conveyor,
Said shuttle can be placed entirely under said tray in an engaged position, in such a way that the footprint of said cart is no greater than the footprint of said tray; this makes it possible to facilitate the installation on the floor and the movements, in particular of several carts at the same time,
Said shuttle can comprise a frame and a lift that can move in vertical translation, and said engagement/disengagement means can comprise said movable lift, configured to raise said tray into the engaged position; this makes it possible to have a very simple engagement/disengagement means, using a support between two surfaces, one of the tray and the other of the shuttle; it is possible, of course, to add thereto other accessories such as hooks or electromagnets, etc.,
Said tray can comprise, at its separate support structure, feet of adjustable height, which makes it possible to adapt it to stations of different height.

This invention also relates to a product processing line comprising stations of which at least one is equipped with a table for supporting and accumulating said products, and at least one cart according to the invention, in which to transfer products, the receiving surface of the tray is arranged at the same height from the floor as said table, so that when said tray is arranged adjacent to said table, the receiving surface is just above said table.

Thanks to these arrangements and compared to the intermediate solution of the carts integrating a shuttle and a tray, the number of shuttles can be less than the number of trays, and it is therefore possible to obtain the same service with fewer shuttles than there would have to be carts in the absence of the invention. Furthermore, the line is more flexible and adaptable, with a high product flow rate, and a movement solution that is not very expensive and is adaptable to all of the products. The transfer of products between tray and table is simple and can be done by a simple horizontal thrust, which makes it possible to use a simple and universal transfer device, operating for many products of different size and shape, since the products are always supported by the bottom.

The line in question ensures the packaging of products that are preferably bottles, flasks, or other containers, in consecutive stations. The containers are preferably filled and form semi-finished elements, to be repackaged subsequently. A station can, of course, receive products from an upstream station, but also from a storage unit, or else deliver products that are either processed downstream on the line, or sent into a storage unit.

This invention also relates to a method for moving products from a first station to a second station of a product processing line, by means of a cart according to the invention, and comprising the following steps:
Transfer of products from said first station to the receiving surface of said cart
Arrival of the shuttle, and engagement of the shuttle with the tray
Movement of the cart to the second station
Disengagement of the shuttle, and departure of the shuttle
Transfer of products from the receiving surface to said second station.

Thanks to these arrangements, the number of shuttles can be less than the number of trays, and it is therefore possible to obtain the same service with fewer shuttles than there would have to be carts in the absence of the invention.

According to other characteristics:
The products can be arranged on said receiving surface in consecutive, non-staggered rows, i.e., the products of one row do not impinge upon an adjacent row, even for round products such as bottles, which provides the possibility of reconstituting a single row without any particular difficulty,
Said tray can comprise at least one edge, preferably four edges, and said edge, preferably the four edges, can be active during the step of movement of the cart and retracted during the steps of transfer of the products, which makes it possible to improve the holding of products during the movement, while preserving ease of transfer.

This invention will be better understood from reading the following detailed description, with reference to the accompanying figures, in which:

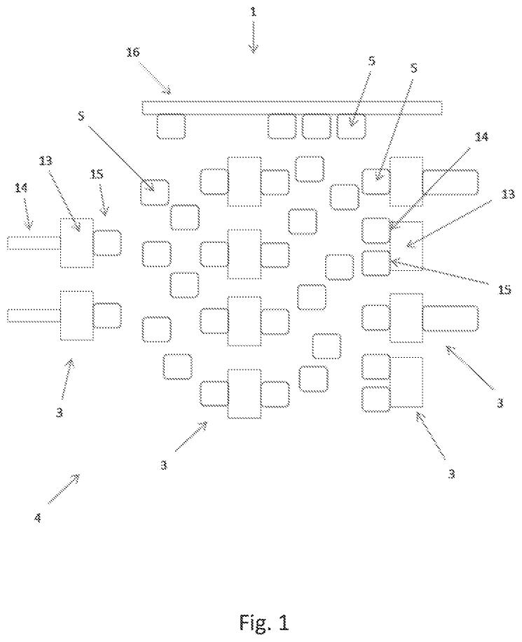

FIG. 1 is a view [that] shows a line according to the invention, upstream from a logistical shipping center,

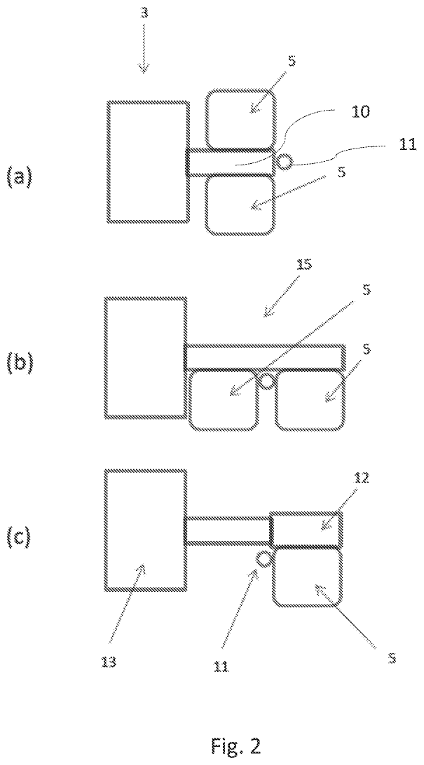

FIG. 2 shows in diagram form the possibilities for exiting a processing station in three configurations: 2a, 2b, and 2c,

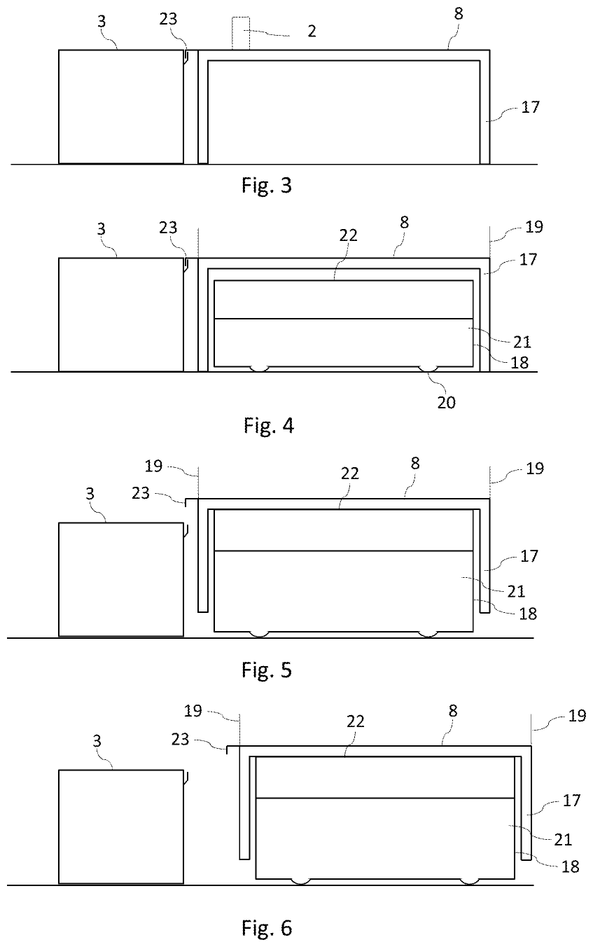

FIGS. 3 to 6 illustrate a cart according to the invention during four consecutive steps.

The invention thus first of all has as its object a line 1 for chain-processing of products 2, comprising, on the one hand, a number of stations 3 for consecutive processing of said products 2, and, on the other hand, a movement means 4, for moving the products 2 between the stations 3 within this line 1, in particular from an upstream station 3 in which they are processed to a downstream station 3 in which they are next to be processed.

The products 2 are in particular of the liquid container type, such as a bottle, empty or full, food item, case, box, carton, empty or full, etc.

The processing line 1 employed in using this type of movement means can be the complete system that ensures the complete processing from the manufacturing of the product 2 to its palleting ready for subsequent tracking at a logistical sorting center or for shipping, or only a part of such a system, in particular, for example, a block of stations 3 within such a complete system for preparation for shipping. The expected flow rates within such a line 1 processing the products 2 one at a time are significantly higher than those, upstream or downstream, processing pallets, on which the number of products 2 is significantly different. The products are generally less stable, and the technical solutions are therefore generally different at least for these two reasons.

The processing stations 3 ensure in particular the transformation of products 2 one at a time, such as filling, labeling, or else of multiple products 2 of the container type simultaneously for grouping them in a pack, of multiple products 2 of the case type for organizing them in a layer on a pallet, etc. The consecutive stations 3 can thus carry out manufacturing, transformation, storage and/or else make a change to the geometric organization of the products 2. Of course, the line 1 has stations 3 that receive their products 2 from the outside, both as raw material for the line 1 as well as stations 3 that provide on the outside the products 2 at the end of processing via the line 1. The line 1 therefore participates in the preparation upstream of units for logistical shipping, generally based on pallets rather than on management, allocation and distribution of these units.

A station 3 can thus be used to store the products 2 temporarily, optionally in a semi-finished state. Such a station 3 then receives products 2 from the cart or carts and/or provides the products 2 to the cart or carts. Such storage can be connected outside of the line: coming from it or going to it. In a general way, a transfer of products 2 from the cart therefore takes place in the area of a station 3, where they will be processed, transformed, stored, etc. A station 3 can, for example, consist essentially of a store of trays 17 that are stacked one above the other, or else beside one another.

The line 1 is arranged in a suitable workshop or hall, and the stations 3 preferably rest on the floor. The movement means 4 that is conventionally used in the state of the art is based on conveyors with movable endless belts, mounted on a stationary structure that is placed on the floor in the workshop. The operators of the line 1 move about in this workshop, and it is then necessary to provide in particular walkways for circumventing such movement means 4. The stations 3 are difficult to move and are generally anchored to the floor.

According to the invention, the movement means 4 essentially consists of at least one autonomous, self-supported movable cart 5 that maneuvers on the floor and on which the products 2 rest during their movement within the line 1, preferably a fleet of such carts 5 that can navigate between the stations 3 of the line 1. It is not necessary that the carts 5 return to the pieces of equipment or other machines that are outside of the line 1, but they can be dedicated to the stations 3 of the line 1. The carts 5 therefore connect the various stations 3 of the line 1 and ensure the circulation of the flow of products 2 within the line 1.

Using carts 5 thus ensures maximum flexibility based on the number of products 2 to be processed with the defined format, but also based on the stations 3 that are involved in the production of the defined format, etc.

It will be understood that these carts 5 form vehicles or shuttles that are autonomous, capable of moving multiple products 2 between two consecutive stations 3 at the same time. The movement of these carts 5 therefore creates the movement of the products 2 between the stations 3. The at least one cart 5 therefore moves during the production via the line 1. In addition, it will be understood that the line 1 comprises a number of trays 17 and optionally a number of shuttles 18. A shuttle 18 can work with multiple different trays 17 each time to then form a cart 5. The combinations of a shuttle 18 and a tray 17 for forming a cart 5 are multiple and depend on the number of each of them in the line 1.

According to a possible additional characteristic, the at least one movable cart 5 is equipped with an on-board drive, in such a way that said cart 5 can itself generate its own movement, in particular in the form of a drive unit, a transmission, and a set of wheels. Said movable cart 5 is thus movable between the stations 3, in such a way as to reach maximum flexibility in the paths to be followed based on optionally movable elements from the environment that it is necessary to avoid, such as operators and even other carts 5 or shuttles 17.

The movable cart 5 has, on the one hand, a surface 8 for receiving products 2, on which surface the products 2 can rest by their lower part, and, on the other hand, a frame on which is mounted at least the on-board drive. The receiving surface 8 is preferably horizontal, flat, and may arrive at the level of the exit from the upstream station 3 and/or at the level of the entrance of the downstream station 3 upon the transfer of products 2. The cart 5 can be equipped with multiple stacked receiving surfaces 8, if necessary.

For its interaction with the stations 3, the movable cart 5 can also comprise in particular docking means that ensure mechanical interfacing and proper positioning with the station 3 where it receives the products 2 and/or the station 3 to which it delivers the products 2. These docking means can be in particular mechanical means for referenced positioning, for example by complementary parts such as cones or another conventional solution.

The cart 5 also optionally comprises an energy reserve for the operation of the on-board—in particular electric—drive, with the line then being provided with an electrical power supply means for recharging the cart 5, for example when it is docked at a station 3 or in circulation.

According to another advantageous characteristic, the line 1 can comprise, in addition, a receiving station 16 for temporarily receiving, during their trip between the stations 3, carts 5, loaded or not with products 2, and optionally only the trays 17, in such a way as thus to ensure an accumulation zone in the case of the impossibility for the destination station 3 of receiving the products 2 or the impossibility for the original station 3 of providing the products 2. The line 1 can thus have at least one accumulation zone, in which the trays 17 are arranged.

According to another possible additional characteristic, each station 3 is equipped with a transfer means for collecting the products 2 to be processed that are present on the carts 5 and/or for depositing the processed products 2 on the carts 5, in particular a transfer means that comprises a manipulator 11. This transfer means thus performs the movement of the products 2 between the receiving surface 8 and either an entry zone 14 or an exit zone 15 of the station 3. In a general way, this transfer means can also be mounted on the carts 5. Thus, in particular embodiments, the at least one cart 5 is equipped with a transfer means, for collecting, in the area of the exit zone 15 of a station 3, the products 2 that are processed by it and that are to be moved toward a downstream station 3, and/or for depositing the products 2—that were previously processed by an upstream station 3 and that it has moved—at the entry zone 14 of a downstream station 3.

Said transfer means, mounted on a station 3 or a cart 5, relies on, for example, a multi-axis robotic solution or a robotic solution with slides, optionally with a complementary conveyance of the endless-belt type.

According to another possible additional characteristic, the stations 3 process the products 2 one at a time and are each equipped with a means for one-at-a-time feeding of the endless-belt-conveyance type, as well as a means for one-at-a-time extraction of the endless-belt-conveyance type, with the carts 5 ensuring the movement of a batch of similar products 2 each time between the stations 3. These conveyances are respectively located in the entry zone 14 and the exit zone 15. It is understood that any configuration is conceivable: the carts 5 can, on the one hand, receive batches of products 2 that form segments of a single column or of multiple columns, and, on the other hand, provide batches of products 2 that form segments of a single column or of multiple columns. The station 3 can be equipped with a solution for transforming the flow, for converting the single-line flow into a multi-line flow, or vice versa. Thus, the products 2 that are transferred to or from a cart 5 can be in the form of a single column or of multiple columns.

It can thus be particularly advantageous to receive, in the exit zone 15 of a station 3, the products 2 in a single-line column cut successively into batches that are to be processed and to be accumulated transversely on the cart 5, and then, for the unloading, in the entry zone 14 of the downstream station 3, to move multiple such batches simultaneously from the cart 5. Owing to the principle of transfer on the cart 5, which is based on a transverse transfer of consecutive portions of a flow, the products 2 are therefore stored on the cart 5 in a non-staggered matrix and can then be provided at the downstream station 3 with such an organization: it is possible to transfer one or multiple parallel segments simultaneously.

The invention also has as its object a cart 5 that comprises, by themselves or in combination, the characteristics that are described here and that are necessary for making possible the embodiment of a line 1 according to the invention. In possible embodiments of this cart 5, it has a surface 8 for receiving products 2 on which said products can rest on their low part, i.e., the bottom, with said receiving surface 8 having an essentially rectangular shape, flat, preferably without rough spots, with the processed products 2 being fed on one side of said surface and brought out from the opposite side and accumulated in adjacent rows between these sides, in such a way as to ensure that the first product that has entered is the first product that exits.

The cart 5 can comprise—in a manner separable from one another—on the one hand, a tray 17, comprising the receiving surface 8 and a separate supporting means, such as feet, and, on the other hand, a shuttle 18 comprising said on-board drive.

The receiving surface 8 can comprise at least one, preferably four, retractable edge(s) 19. This makes it possible to keep the products 2 on the receiving surface 8 during the movement of the cart 5.

When the cart 5 is in place against a station 3, at least one edge 19 can then be retracted, which makes it possible, when the receiving surface 8 of the cart 5 is just above the surface of the station 3, to transfer the products 2 from the station 3 to the cart 5 or vice versa, by a transfer means that is a simple lateral thrust means, if necessary a means that is configured to push at least one row of products 2 at the same time, thus making it possible to transfer non-staggered products 2, by maintaining their non-staggered arrangement after the transfer. The thrust means can, of course, also be configured to push only a portion of one row.

Such a transfer means, if necessary a thrust means, can also be arranged as a device that is attached to said tray 17, which makes it possible to adapt it specifically to the receiving surface 8 of the tray 17. This requires arrangements for the loading of products 2 that are located at the station 3, making it possible for said transfer means to go search for them.

Such a transfer means, if necessary a thrust means, can also be arranged as a device that is attached to the station 3 and is configured in such a way as to be able to unload the tray 17 and to load it.

Finally, it is possible to provide that the stations 3 and the trays 17 each comprise a transfer means or thrust means. Such a solution has the advantage that the transfer means of the station 3 may be able only to load the tray 17, and the transfer means of the tray 17 may be able only to unload the tray 17, for example. It is possible to imagine other allocations of the functions. This can make it possible to use simpler transfer means, which in some cases can be less complex and less costly than a smaller number of more complex transfer means.

The shuttle 18 can comprise casters 20, for example multidirectional casters 20. It can comprise a frame 21 that is arranged on said casters 20 and that can therefore move in all directions on an essentially horizontal surface. The shuttle 18 can then comprise a lift 22 that can move in vertical translation in relation to the frame 21, to raise the tray 17 from the floor.

Thus, as illustrated in FIG. 3, a tray 17 can be docked at a station 3. It is possible to provide a hook 23, configured to attach the tray 17 to the station 3.

It is also possible to transfer all or part of the products 2 from the tray 17 to an intermediate accumulation surface, or table, from which the products 2 are then brought to the conveyor 10, and vice versa for a transfer from the tray 17, to an accumulation surface, and then to the conveyor 10.

In these cases, an accumulation surface extends along the conveyor 10, and the trays 17 come against said surface. It is thus possible to ensure a transfer of the products 2 from the conveyor, over the accumulation surface and then over the tray 17, or, conversely, a transfer from the tray 17, up to the accumulation surface, up to the conveyor 10. These transfers are then made transversely to the direction of advance of the conveyor 10.

More specifically, it is possible to envision a configuration comprising
A conveyor that is downstream from the station 3, on which the latter delivers products 2,
An intermediate accumulation surface, or table, against an edge from which said conveyor extends,
A loading means, which transfers—by transverse flushing in the conveyor—the products 2 from the conveyor up to the accumulation surface,
An unloading means, which transfers—in the area of the edge of the accumulation surface that is opposite to the one where the loading means is located—products 2 on a tray 17, transversely to the direction of the conveyor,
A shuttle 18 that can be coupled to the tray 17 in order to move it.

The reciprocal configuration can be envisioned, namely, besides the indications above:
The conveyor is upstream from the station 3 and feeds it with products
The loading means and unloading means are reversed
With the shuttle moving the tray 17 so that it feeds the line with products 2.

The loading and unloading transfers are easy and are ensured by a sweep over surfaces that are mounted just above. As illustrated in FIG. 4, a shuttle 18, with a lift 22 in a low position, can be placed under the tray 17. It is possible to provide that as soon as the shuttle is in position under the tray 17, the retractable edges 19 of the tray 17 are put back in place to ensure that the products 2 are firmly held.

As illustrated in FIG. 5, it is then possible to raise the lift 22. The shuttle 18 then engages with the tray 17, by resting [on the] horizontal plane of two surfaces, raises it, and, if necessary, unhooks it from the station 3 in the area of the hook 23.

FIG. 6 illustrates that the cart 5, consisting of the shuttle 18 and the tray 17 that are made integral with one another, can then move, can leave the station 3, in order to go to another station 3, or any other destination provided.

Upon arriving at another station 3, the procedure is then done in reverse order:
Approach of the cart 5 that consists of the shuttle 18 and the tray 17 (FIG. 6),
Stopping in position of the cart 5 (FIG. 5),
Dropping of the lift 22 until the tray 17 rests on its feet, and a little more to disengage the shuttle 18 from the tray 17 (FIG. 4),
Retraction of the edges 19 and departure of the shuttle 18 (FIG. 3).

The tray 17 is then attached to the station 3, and the transfer of products 2 can be done. During the entire period that is necessary for the transfer of products 2 between the tray 17 and the conveyor 10, the shuttle 18 can go move another tray 17, and then return to move the latter when it will be necessary to do so. Another shuttle 18 can also move this tray 17 as soon as it is necessary, with multiple shuttles 18 that can be compatible with each tray 17, provided that cooperation by resting flat for the purpose of engagement between the shuttle 18 and the tray 17 is possible.

Thus, to use a number N of operational carts 5, it is necessary to provide N trays 17, but a smaller number of shuttles 18 is possible. This therefore makes it possible to reduce the investment cost significantly; actually, the cost of the on-board drive of the shuttle 18 represents a large part of the cost of a cart 5.

It is also possible to provide that the unloading of the products 2 begins as soon as the tray 17 is in place and before the shuttle 18 has departed. It is also possible to provide that the shuttle 18 will be inserted under the tray 17 while the loading is not yet terminated and thus to avoid a waiting period between the end of loading of the tray 17 and the beginning of its movement by the shuttle 18.

It is possible to use a tray 17 on a single level, at a height that is suitable for an operator's work. It is also possible, however, to envision trays 17 at multiple levels (not shown), and a shuttle 18 that is suitable for raising its lift 22 at multiple lifting intervals, each corresponding to the position where one of the levels of the tray 17 is just above the receiving table of the station 3.

According to another embodiment, it is possible to provide that the trays 17 comprise casters, giving them a possibility of short autonomous movement, without using a shuttle 18.

According to another embodiment, the height of the trays 17 can be adjustable. This makes it possible to use the same trays 17 for different production lines, in which the stations 3 would have a different receiving surface height.

It is also possible to provide a tray 17 height that can be adjusted automatically to make possible a transfer to a station 3 with a different receiving surface from other stations 3, for ergonomic reasons, for example.

The interface between a tray 17 and a shuttle 18 can be a flat surface, making possible good engagement during movement. Disengagement then amounts to providing a space between the tray 17 and the shuttle 18, so that the shuttle 18 can travel without taking away the tray 17.

In the description above, in relation to FIGS. 3 to 6, it is assumed that the shuttle 18 is placed below the tray 17 and then is raised to take it away. This constitutes a simple embodiment, with as an advantage in particular, as regards the fact that the shuttle 18 is placed under the tray 17, of less space required for a cart 5 that consists of such a tray 17 and such a shuttle 18 and as regards the raising, a reliable simple engagement of the tray 17 with the shuttle 18, and the possibility of moving the trays 17 without using either casters or any other autonomous movement means. It is specified that the simple raising of the tray by the shuttle constitutes an engagement means. Actually, after raising, if the shuttle moves, the tray necessarily accompanies it: they are therefore integral.

However, other solutions are possible.

It is also possible to provide that the shuttle 18 is placed effectively under the tray 17, but does not raise it. It is engaged by, for example, hooks, or electromagnets, and entrains the tray, which rolls on its casters.

It is also possible to provide that the shuttle 18 is placed beside a tray 17, is engaged by hooks or electromagnets, and then drives the tray 17 for the movement, which then takes advantage of its own casters during the movement, or then the shuttle 18 raises the tray 17 by an accompanying device and can then move the trays 17 with neither casters nor autonomous movement means.

In a general manner, the products 2 that are processed within the line for chain-processing of products 2 are bottles, flasks, or other containers.

These are therefore products that are said to be unstable to the extent that their largest dimension, also called height, is placed perpendicular to their base on which they rest. Actually, such products can easily tip over when they are removed from their positions of equilibrium. In other words, these products 2 are upright.

Thus, so as to prevent products 2 from falling during their transport and during their transfer between the tray and a station 3, the receiving surface 8 is preferably flat and horizontal. In addition, this surface can be made of a material such that the friction coefficient between this surface 8 and the products 2 has a favorable value so that the products 2 remain upright without sliding during the movement of the cart 5. One skilled in the art, because of his general knowledge, is able to select a material meeting the above-mentioned criteria.

However, when the products 2 are arranged on the tray 17 by forming non-staggered rows, a retractable system that is formed by parallel vertical walls can be arranged prior to the movement of the cart 5, in such a way that a wall is located between each row so as to ensure that the products 8 remain in place. Such a system is then removed for the unloading of the tray 17. In certain embodiments, the products 2 are aligned in two directions that are perpendicular to one another, still without staggering. They then form lines and columns. In this case, the retractable system can be formed by vertical walls forming a grid pattern in such a way that each product 2 of the tray 17 is isolated from the others using walls. Thus, two products 2 cannot come into contact.

The tray 17 can comprise one or more conveyor(s) formed by an endless belt that is wound around two roll-up drums (called upstream and downstream) located respectively in the area of the two opposite edges of the receiving surface 8. When there are multiple conveyors, they are generally placed side by side, and the axes of the upstream roll-up drums are preferably aligned. The same is true for the axes of the downstream roll-up drums. The receiving surface 8 is then formed by one or more endless belt(s). It is flat and horizontal between the upstream and downstream roll-up drums that are located in the area of two opposite edges of this surface 8. In this case, the roll-up drums are preferably as fine as possible so as to limit any risk of falling during the transfer of the products 2. Such (an) endless belt(s) can then contribute to the transfer of products 2 from or to a station 3.

In the field of the invention, the production and packaging lines deliver products 2 in a continuous flow and at high speed, i.e., on the order of several tens of thousands of products 2 per hour. The connection of one station 3 to the next should therefore be compatible with the required speeds.

Consequently, the receiving surface 8 has compatible dimensions for supporting a large number of products 2. Preferably, the same tray 17 can receive at least 20 products 2, in particular at least 50 products 2, and even more preferably at least 100 products 2. Generally, a cart 5 can transport several hundreds of products 2 on the same tray 17. In this manner, a large number of products 2 is moved simultaneously from one station 3 to the next, which makes it possible to absorb the flow of products 2 exiting from a station 3 to bring it to another station without having to stop the machine.

In a general manner, the stations 3 of a chain-processing line in accordance with the invention are processing machines that are stationary within the factory. Thus, when such stations are equipped with a table for supporting and accumulating products, such a table is also stationary. Generally, such a table is located at the outlet of a station 3, so that the station 3 can continue to deliver products 2 during the loading of a tray 17 and when awaiting the arrival of a new tray 17 that is to be loaded.

Within the framework of this invention, it should be noted that the trays 17 play the roles of conveyor and accumulation table at the same time. Actually, the carts 5 move the products 2 from one processing station 3 to the next, but the products 2 do not necessarily supply the next station 3 as quickly as possible after their transfer to a receiving surface 8. Actually, the products 2 can be placed on standby, i.e., they can remain on a tray 17 until the next station 3 is ready to receive new products 2.

As a result, this invention is compatible with production and packaging in a continuous flow and at high speed. It advantageously makes it possible to improve the flexibility of a chain line while using a minimum number of shuttles 17 and without impacting the production capacity of a line.

Although the description above is based on particular embodiments, it is in no way limiting of the scope of the invention, and modifications can be provided, in particular by substituting technical equivalents or by combining some or all of the characteristics developed above in different ways.

1. Cart (5) for moving bottle-type products (2) from one station (3) to the next on a line (1) for processing said products (2), with said cart (5) being able to move on a floor and comprising an autonomous drive means that is configured to enable the cart to move from one predefined station (3) to another predefined station (3), said cart (5) comprising a tray (17), equipped with a receiving surface (8) that can receive a number of products (2), and a shuttle (18), equipped with said autonomous drive means and an engagement/disengagement means in relation to said tray (17).

2. Cart (5) according to claim 1, in which said tray (17) comprises at least one retractable edge (19), configured to be able to be active, and to keep the products (2) inside said receiving surface (8), and to be able to be retracted to make possible a transfer by lateral thrust from one surface to the next.

3. Cart (5) according to claim 1, in which said tray (17) comprises a separate support structure.

4. Cart (5) according to claim 1, in which said shuttle (18) is arranged entirely below said tray (17) in an engaged position, in such a way that the footprint of said cart (5) is no greater than the footprint of said tray (17).

5. Cart (5) according to claim 1, in which said shuttle (18) comprises a frame and a lift (22) that is movable in vertical translation, and said engagement/disengagement means comprises said lift (22), configured to raise said tray (17) into an engaged position.

6. Cart (5) according to claim 1, in which said tray (17) comprises feet of adjustable height.

7. Line (1) for processing products (2) comprising stations (3) of which at least one is equipped with a table for supporting and accumulating said products (2), and at least one cart (5) according to claim 1, in which to transfer the products (2), the receiving surface (8) of the tray (17) is arranged at the same height from the floor as said table, so that when said tray (17) is arranged adjacent to said table, the receiving surface (8) is just above said table.

8. Method for moving products (2) from a first station (3) to a second station (3) of a line (1) for processing products (2), by means of a cart (5) according to claim 3, and comprising the following steps:
Transfer of products (2) from said first station (3) to the receiving surface (8) of said cart (5),
Arrival of the shuttle (18), and engagement of the shuttle (18) with the tray (17),
Movement of the cart (5) to the second station (3),
Disengagement of the shuttle (18), and departure of the shuttle (18),
Transfer of products (2) from the receiving surface (8) to said second station (3).

9. Method according to claim 8, in which the products (2) are arranged on said receiving surface (5) in consecutive, non-staggered rows.

10. Method according to one of claim 8, and said edge (19) is active during the step of movement of the cart (5) and retracted during the steps of transfer of the products (2).

11. Method according to claim 8, in which said engagement of the shuttle and the tray consists in lifting said tray by said shuttle, and said disengagement consists in dropping said tray until it rests on its own feet-type supporting means.

12. The cart according to claim 2, in which said tray comprises a separate support structure.

13. The cart according to claim 2, in which said shuttle is arranged entirely below said tray in an engaged position, in such a way that the footprint of said cart is no greater than the footprint of said tray.

14. The cart according to claim 3, in which said shuttle is arranged entirely below said tray in an engaged position, in such a way that the footprint of said cart is no greater than the footprint of said tray.

15. The cart according to claim 2, in which said shuttle comprises a frame and a lift that is movable in vertical translation, and said engagement/disengagement means comprises said lift, configured to raise said tray into an engaged position.

16. The cart according to claim 3, in which said shuttle comprises a frame and a lift that is movable in vertical translation, and said engagement/disengagement means comprises said lift, configured to raise said tray into an engaged position.

17. The method of claim 10, wherein the tray comprises four of the retractable edges.

18. The cart according to claim 3, wherein the the support structure comprises feet.

19. The cart according to claim 18, wherein the feet comprise casters.

20. The cart according to claim 2, wherein the tray comprises four of the retractable edges.
